(19) United States
(12) Patent Application Publication
(10) Pub. No.: US 2024/0388645 A1
(43) Pub. Date: Nov. 21, 2024

(54) PREEMPTIVE CACHING ACTION BASED ON END-USER CUES

(71) Applicant: T-MOBILE INNOVATIONS LLC, Overland Park, KS (US)

(72) Inventors: Peter Philip MYRON, New Braunfels, TX (US); Michael John MITCHELL, North Bend, WA (US)

(21) Appl. No.: 18/199,168

(22) Filed: May 18, 2023

(51) Int. Cl. H04L 67/5683; G06F 3/0487; H04L 67/50

(52) U.S. Cl. CPC H04L 67/5683; G06F 3/0487; H04L 67/535

(57) ABSTRACT

Systems, methods, and computer-readable media are provided for performing a caching action based on end-user cues. An indication corresponding to the intent of a user is initially detected at a sensor associated with a display providing content. Based on the indication and historical information, the intent of the user is predicted. A caching action corresponding to additional content is provided based on the intent of the user. For example, the caching action may be to preemptively cache the additional content. Alternatively, the caching action is to cease preemptively caching the additional content.

### SUMMARY

A high-level overview of various aspects of the invention is provided here as an overview of the disclosure and to introduce a selection of concepts further described below in the detailed description. This summary is not intended to identify key features or essential features of the claimed subject matter, nor is it intended to be used as an aid in isolation to determine the scope of the claimed subject matter.

In brief and at a high level, this disclosure describes, among other things, systems, methods, and computer-readable media that perform a caching action based on end-user cues. An indication corresponding to the intent of a user is initially detected at a sensor associated with a display providing content. Based on the indication and historical information, the intent of the user is predicted. A caching action corresponding to additional content is provided based on the intent of the user. For example, the caching action may be to preemptively cache the additional content. Alternatively, the caching action is to cease preemptively caching the additional content.

### BRIEF DESCRIPTION OF THE SEVERAL VIEWS OF THE DRAWINGS

Illustrative embodiments of the present invention are described in detail below with reference to the attached drawing figures, and wherein:

FIG. 1 depicts a schematic for an exemplary system, in accordance with an embodiment of the present invention;

FIG. 2 depicts a diagram of a preemptive content fetching engine, in accordance with aspects herein;

FIG. 3 depicts an exemplary method for preemptively caching additional content based on the intent of the user, in accordance with aspects herein;

FIG. 4 depicts an exemplary method for ceasing preemptively caching additional content based on the intent of the user, in accordance with aspects herein; and

FIG. 5 depicts an exemplary computing device suitable for use in implementations of aspects herein.

### DETAILED DESCRIPTION

The subject matter of select embodiments of the present invention is described with specificity herein to meet statutory requirements. The Detailed Description is not intended to define what is regarded as the invention, which is the purpose of the claims. The claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

Throughout the description of the present invention, several acronyms and shorthand notations are used to aid the understanding of certain concepts pertaining to the associated system and services. These acronyms and shorthand notations are solely intended for the purpose of providing an easy methodology for communicating the ideas expressed herein and are in no way meant to limit the scope of the present invention. The following is a list of these acronyms:

| | |
|---|---|
| AWS | Advanced Wireless Services |
| BRS | Broadband Radio Service |
| BTS | Base Transceiver Station |
| CDMA | Code Division Multiple Access |
| EBS | Educational Broadband Services |
| eNodeB | Evolved Node B |
| EVDO | Evolution-Data Optimized |
| gNodeB | Next Generation Node B |
| GPS | Global Positioning System |
| GSM | Global System for Mobile Communications |
| HRPD | High Rate Packet Data |
| eHRPD | Enhanced High Rate Packet Data |
| LTE | Long Term Evolution |
| LTE-A | Long Term Evolution Advanced |
| PCS | Broadband Personal Communications Service |
| RNC | Radio Network Controller |
| SyncE | Synchronous Ethernet |
| TDM | Time-Division Multiplexing |
| VOIP | Voice Over Internet Protocol |
| WAN | Wide Area Network |
| WCS | Wireless Communications Service |
| WiMAX | Worldwide Interoperability for Microwave Access |

Further, various technical terms are used throughout this description. A definition of such terms can be found in, for example, Newton's Telecom Dictionary by H. Newton, 31 st Edition (2018). These definitions are intended to provide a clearer understanding of the ideas disclosed herein but are not intended to limit the scope of the present invention. The definitions and terms should be interpreted broadly and liberally to the extent allowed by the meaning of the words offered in the above-cited reference.

Embodiments of the present technology may be embodied as, among other things, a method, system, or computer program product. Accordingly, the embodiments may take the form of a hardware embodiment, or an embodiment combining software and hardware. An embodiment takes the form of a computer program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, navigating web pages on some devices and for some end-user conditions and situations can be tedious work. Content only begins to load when a user performs some action, such as selecting and clicking on a particular link. The user experience can be degraded by network latency or delays while the content corresponding to the selected link is loaded.

At a high level, systems, methods, and computer-readable media of the present invention perform a caching action based on end-user cues. An indication corresponding to the intent of a user is initially detected at a sensor associated with a display providing content. Based on the indication and historical information, the intent of the user is predicted. A caching action corresponding to additional content is provided based on the intent of the user. For example, the caching action may be to preemptively cache the additional content. Alternatively, the caching action is to cease preemptively caching the additional content.

In this way, aspects herein remove network latency and delays while the content corresponding to a predicted link is loaded. For example, changes in gaze can be detected and matched to an actionable target on a webpage or application (i.e., predicted intent of the user). A machine learning model can be trained to predict high-probability actions based on the changes in gaze. Although described with respect to gaze, it should be appreciated that other changes such as pressure detection, movement detection, and hover detection are contemplated and within the scope of the invention. The webpage or application can take preemptive action to fetch additional content corresponding to the intent of the user. Additional content can begin being loaded in the background without changing the appearance of the present content. Accordingly, problems associated with network latency and load times are reduced or eliminated when the user actually selects a link corresponding to the additional content. In some aspects, the predicted intent of the user may cause the webpage or application to cease preemptively caching additional content if it is determined the user is not likely to select a predicted link. Such preemptive action is beneficial because it eliminates extraneous network calls.

Accordingly, in a first aspect of the present invention, computer-readable media is provided, the computer-readable media having computer-executable instructions embodied thereon that, when executed, perform a method for performing a caching action based on end-user cues. The method comprises detecting, at a sensor associated with a display providing content, an indication corresponding to the intent of a user. The method also comprises predicting the intent of the user based on the indication and historical information. The method further comprises preemptively caching additional content based on the intent of the user.

In a second aspect of the present invention, a method for performing a caching action based on end-user cues is provided. The method comprises detecting, at a sensor associated with a display providing content, an indication corresponding to the intent of a user. The method also comprises predicting the intent of the user based on the indication and historical information. The method further comprises ceasing preemptively caching additional content based on the intent of the user.

In a third aspect of the present invention, a system for performing a caching action based on end-user cues is provided. The system comprises at least one processor and one or more computer storage media storing computer-readable instructions that when executed by at least one processor, cause at least one processor to perform operations. The operations comprise detecting, at a sensor associated with a display providing content, an indication corresponding to the intent of a user. The operations also comprise predicting the intent of the user based on the indication and historical information. The operations further comprise performing a caching action corresponding to additional content based on the intent of the user.

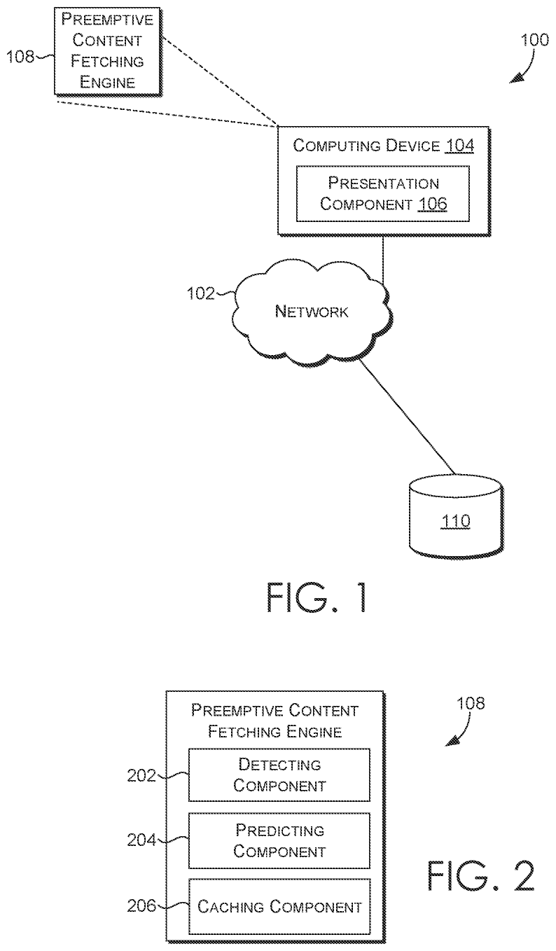

Turning now to FIG. 1, a block diagram is provided showing an operating environment 100 in which aspects of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

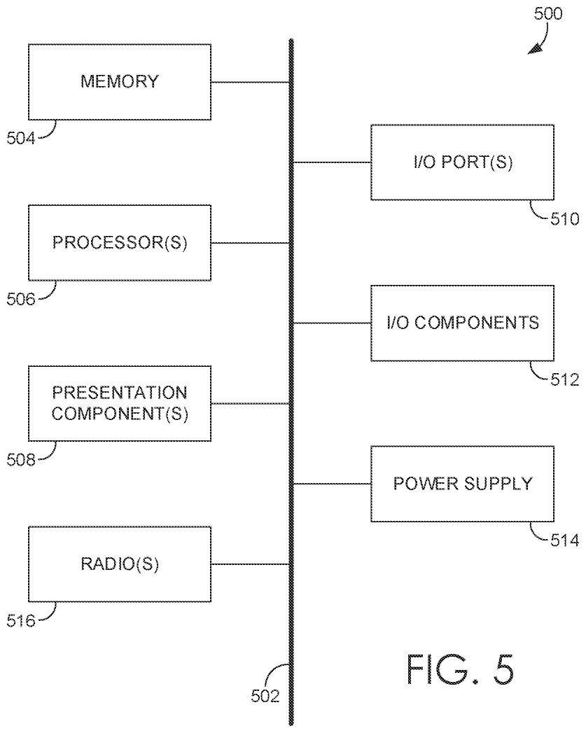

Among other components not shown, example operating environment 100 includes a network 102; a computing device 104 having a client interface component 106; database 110; and preemptive content fetching engine 108. It should be understood that environment 100 shown in FIG. 1 is an example of one suitable operating environment. Each of the components shown in FIG. 1 may be implemented via any type of computing device, such as computing device 500, described below in connection to FIG. 5, for example.

It should be understood that any number of computing devices and data sources may be employed within the operating environment 100 within the scope of the present disclosure. Each may comprise a single device or multiple devices cooperating in a distributed environment. For instance, the preemptive content fetching engine 108 may be provided via multiple devices arranged in a distributed environment that collectively provide the functionality described herein. Additionally, other components not shown may also be included within the distributed environment.

The computing device 104 may utilize network 102 to communicate with other computing devices (e.g., mobile device(s), a server(s), a personal computer(s), etc.) such as a webpage or application provider (not shown) providing content 110. In some aspects, network 102 comprises a local area network (LAN) and/or a wide area network (WAN). Such networking environments are commonplace in offices, enterprise-wide computer networks, intranets, and the Internet. In some aspects, network 102 is a telecommunications network, or a portion thereof. A telecommunications network might include an array of devices or components, some of which are not shown to not obscure more relevant aspects of the invention. Components such as terminals, links, and nodes (as well as other components) may provide connectivity in some embodiments. Network 102 may include multiple networks, as well as being a network of networks, but is shown in a more simple form to not obscure other aspects of the present disclosure. Network 102 may be part of a telecommunications network that connects subscribers to their immediate service provider. In embodiments, network 102 is associated with a telecommunications provider that provides services to user devices, such as computing device 104. For example, network 102 may provide voice services to user devices or corresponding users that are registered or subscribed to utilize the services provided by a telecommunications provider. Although it is contemplated network 102 can be any communication network providing voice and/or data service(s), such as, for example, a 1× circuit voice, a 3G network (e.g., CDMA, CDMA1000, WCDMA, GSM, UMTS), a 4G network (WiMAX, LTE, HSDPA), a 5G network, or the like.

The computing device 104 may comprise any type of computing device capable of use by a user. For example, in one aspect, the computing device 104 may be the type of computing device 500 described in relation to FIG. 5 herein. The computing device 104 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, computing device 104 comprises a wireless or mobile device with which a wireless telecommunication network(s) can be utilized for communication (e.g., voice and/or data communication). In this regard, the computing device 104 can be any mobile computing device that communicates by way of, for example, a 5G network. A user may be associated with the computing device 104. The user may communicate with the preemptive content fetching engine 108 through one or more computing devices, such as the computing device 104.

Continuing, the network environment 100 may further include a preemptive content fetching engine 108. The preemptive content fetching engine 108 may be configured to, among other things, perform a caching action corresponding to additional content based on the intent of the user, in accordance with the present disclosure. In some configurations, the preemptive content fetching engine 108 may be implemented at least partially or entirely on a computing device, such as computing device 104. In other configurations, the preemptive content fetching engine 108 may be embodied on one or more servers. The preemptive content fetching engine 108 (and its components) may be embodied as a set of compiled computer instructions or functions, program modules, computer software services, or an arrangement of processes carried out on one or more computer systems, that are able to receive or detect an indication corresponding to intent of a user based on sensor information corresponding to a sensor associated with the computing device 104 or the presentation component 106.

The network environment 100 may include a database storing content 110. The database may be similar to the memory component 512 in FIG. 5 and can be any type of medium that is capable of storing information. The database can be any collection of content 110 (e.g., webpage or application content). In one embodiment, the database includes a set of embodied computer-executable instructions that, when executed, facilitate various aspects disclosed herein. These embodied instructions will variously be referred to as “instructions” or an “application” for short.

Referring now to FIG. 2, the preemptive content fetching engine 108 may include, among other things, detecting component 202, predicting component 204, and caching component 206. The preemptive content fetching engine 108 may communicate data to or receive data from computing devices, such as computing device 104 and/or webpage or application provider associated with content 110.

Detecting component 202 generally detects, at a sensor associated with a display providing content, an indication corresponding to the intent of a user. In various embodiments, the sensor corresponds to gaze detection, pressure detection, movement detection, and/or hover detection. For example, the sensor may detect the gaze of the user moving in a particular direction of the display or interface. In another example, the sensor may detect the user exerting an increased or decreased amount of pressure on a particular portion of the display, interface, touchscreen, touchpad, or keyboard. In another example, the sensor may detect movement in the way the user is interacting with a display, interface, touchscreen, touchpad, or keyboard. In yet another example, the sensor may detect the user (e.g., a finger of the user) hovering over the display, interface, touchscreen, touchpad, or keyboard.

Predicting component 204 generally predicts the intent of the user based on the indication and historical information. A machine learning model may be trained with data corresponding to the next action of the user and/or other users after receiving a particular indication. Additionally or alternatively, the machine learning model may be trained with historical data corresponding to the next action of the user and/or other users after being provided particular content. For example, the machine learning model may be trained to predict that when a particular indication is detected, it is likely the user will or will not select a particular link or take a particular action.

Caching component 206 generally performs a caching action corresponding to additional content based on the intent of the user. In some aspects, the caching action is to preemptively cache the additional content. In other aspects, the caching action is to cease preemptively caching the additional content.

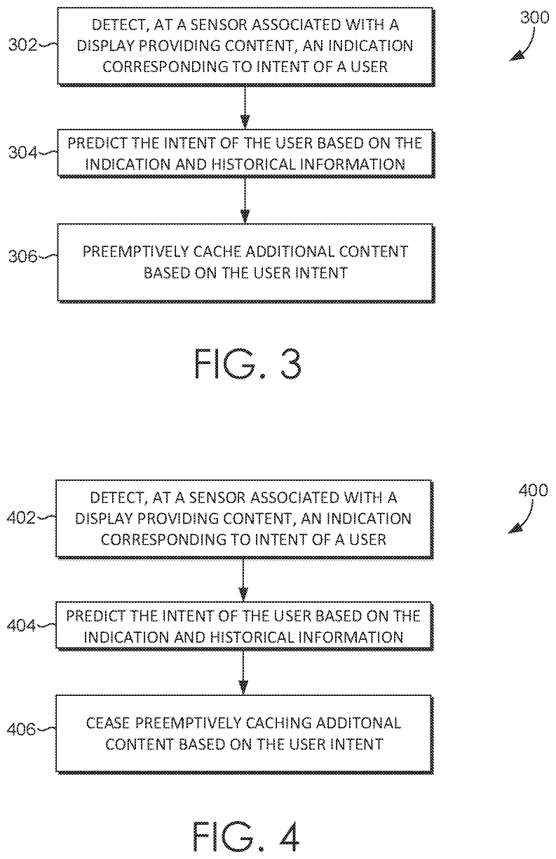

Turning now to FIG. 3, a flow diagram depicting an exemplary method 300 for preemptively caching additional content based on the intent of the user is provided, in accordance with aspects of the present invention. Method 300 may be performed by any computing device (such as computing device described with respect to FIG. 4) with access to a preemptive content fetching engine (such as the one described with respect to FIG. 2) or by one or more components of the network environment described with respect to FIG. 1 (such as UE 102 and/or preemptive content fetching engine 108).

Initially, at step 302, an indication corresponding to the intent of a user is detected at a sensor associated with a display providing content. In some aspects, the indication is based on gaze detection corresponding to the user. For example, the sensor may detect the gaze of the user moving in the direction of a link corresponding to additional content. In some aspects, the indication is based on pressure detection corresponding to a user device. For example, the sensor may detect a pressure change in the way the user is interacting with a display, interface, touchscreen, touchpad, or keyboard indicating the user is likely to select a link corresponding to additional content. In some aspects, the indication is based on movement detection corresponding to a user device. For example, the sensor may detect a movement in the way the user is interacting with a display, interface, touchscreen, touchpad, or keyboard indicating the user is likely to select a link corresponding to additional content. In some aspects, the indication is based on hover detection corresponding to a user device. For example, the sensor may detect the user (i.e., a finger of the user) hovering over a particular portion of the display, interface, touchscreen, touchpad, or keyboard indicating the user is likely to select a link corresponding to additional content.

Accordingly, based on the indication and historical information, the intent of the user is predicted, at step 304. For example, a machine learning model may be trained with data corresponding to the next action of the user and/or other users after receiving a particular indication. Additionally or alternatively, the machine learning model may be trained with historical data corresponding to the next action of the user and/or other users after being provided particular content. For example, the machine learning model may be trained to predict that when the gaze of the user moves in a particular direction, it is likely the user will select a particular link or take a particular action. In another example, the machine learning model may be trained to predict that when the user exerts more pressure on a display, interface, touchscreen, touchpad, or keyboard at a particular location corresponding to the user interface, it is likely to select the user will select a particular a link or take a particular action. In yet another example, the machine learning model may be trained to predict that when the user moves a cursor (or similar position indicator) in a particular direction, it is likely to select the user will select particular a link or take a particular action. In another example, the machine learning model may be trained to predict that when the user (i.e., a finger of the user) hovers over a particular portion of a display, interface touchscreen, touchpad, or keyboard, it is likely to select the user will select a particular a link or take a particular action.

At step 306, additional content is preemptively cached based on the intent of the user. Importantly, the additional content is loaded in the background without changing the display providing the content. In aspects, upon receiving an interaction from the user, the display is changed to provide additional content. Accordingly, the user experience is improved by reducing or eliminating network latency or delays while the additional content corresponding to the selected link is loaded.

In FIG. 4, a flow diagram depicting an exemplary method 400 for ceasing preemptively caching additional content based on the intent of the user is provided, in accordance with aspects of the present invention. Method 400 may be performed by any computing device (such as computing device described with respect to FIG. 5) with access to a preemptive content fetching engine (such as the one described with respect to FIG. 2) or by one or more components of the network environment described with respect to FIG. 1 (such as UE 102 and/or preemptive content fetching engine 108).

Initially, at step 402, an indication corresponding to the intent of a user is detected at a sensor associated with a display providing content. In some aspects, the indication is based on gaze detection corresponding to the user. For example, the sensor may detect the gaze of the user is not moving in the direction of a link corresponding to additional content. In some aspects, the indication is based on pressure detection corresponding to a user device. For example, the sensor may detect a pressure change in the way the user is interacting with a display, interface, touchscreen, touchpad, or keyboard indicating the user is not likely to select a link corresponding to additional content. In some aspects, the indication is based on movement detection corresponding to a user device. For example, the sensor may detect a movement in the way the user is interacting with a display, interface, touchscreen, touchpad, or keyboard indicating the user is not likely to select a link corresponding to additional content. In some aspects, the indication is based on hover detection corresponding to a user device. For example, the sensor may detect the user (i.e., a finger of the user) hovering over a particular portion of the display, interface, touchscreen, touchpad, or keyboard indicating the user is not likely to select a link corresponding to additional content.

Accordingly, based on the indication and historical information, the intent of the user is predicted, at step 404. For example, a machine learning model may be trained with data corresponding to the next action of the user and/or other users after receiving a particular indication. Additionally or alternatively, the machine learning model may be trained with historical data corresponding to the next action of the user and/or other users after being provided particular content. For example, the machine learning model may be trained to predict that when the gaze of the user moves in a particular direction, it is not likely the user will select a particular link or take a particular action. In another example, the machine learning model may be trained to predict that when the user exerts less pressure on a display, interface, touchscreen, touchpad, or keyboard at a particular location corresponding to the user interface, it is not likely to select the user will select a particular a link or take a particular action. In yet another example, the machine learning model may be trained to predict that when the user moves a cursor (or similar position indicator) in a particular direction, it is not likely the user will select a particular link or take a particular action. In another example, the machine learning model may be trained to predict that when the user (i.e., a finger of the user) hovers over a particular portion of a display, interface, touchscreen, touchpad, or keyboard, it is not likely to select the user will select a particular a link or take a particular action.

At step 406, additional content is ceased to preemptively cache based on the intent of the user. Accordingly, the user experience is improved by eliminating extraneous network calls and providing greater bandwidth and resources corresponding to the intent of the user.

Referring now to FIG. 5, a diagram is depicted of an exemplary computing environment suitable for use in implementations of the present disclosure. In particular, the exemplary computer environment is shown and designated generally as computing device 500. Computing device 500 is but one example of a suitable computing environment and is not intended to suggest any limitation as to the scope of use or functionality of the invention. Neither should computing device 500 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 5, computing device 500 includes bus 502 that directly or indirectly couples the following devices: memory 504, one or more processors 506, one or more presentation components 508, input/output (I/O) ports 510, I/O components 512, power supply 514 and radio(s) 516. Bus 502 represents what may be one or more buses (such as an address bus, data bus, or combination thereof). Although the devices of FIG. 5 are shown with lines for the sake of clarity, in reality, delineating various components is not so clear, and metaphorically, the lines would more accurately be grey and fuzzy. For example, one may consider a presentation component, such as a display device to be one of I/O components 512. Also, processors, such as one or more processors 506, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 5 and refer to “computer” or “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media includes RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

Memory 504 includes computer-storage media in the form of volatile and/or nonvolatile memory. Memory 504 may be removable, non-removable, or a combination thereof. Exemplary memory includes solid-state memory, hard drives, optical-disc drives, etc. Computing device 500 includes one or more processors 506 that read data from various entities, such as bus 502, memory 504, or I/O components 512. One or more presentation components 508 presents data indications to a person or other device. Exemplary one or more presentation components 508 include a display device, speaker, printing component, vibrating component, etc. I/O ports 510 allow computing device 500 to be logically coupled to other devices, including I/O components 512, some of which may be built-in computing device 500. Illustrative I/O components 512 include a microphone, joystick, game pad, satellite dish, scanner, printer, wireless device, etc.

Radio 516 represents a radio that facilitates communication with a wireless telecommunications network. Illustrative wireless telecommunications technologies include CDMA, GPRS, TDMA, GSM, and the like. Radio 516 might additionally or alternatively facilitate other types of wireless communications including Wi-Fi, WiMAX, LTE, or other VoIP communications. As can be appreciated, in various embodiments, radio 516 can be configured to support multiple technologies and/or multiple radios can be utilized to support multiple technologies. A wireless telecommunications network might include an array of devices, which are not shown to not obscure more relevant aspects of the invention. Components, such as a base station, a communications tower, or even access points (as well as other components), can provide wireless connectivity in some embodiments.

Many different arrangements of the various components depicted, as well as components not shown, are possible without departing from the scope of the claims below. Embodiments of this technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

1. One or more non-transitory computer-readable media having computer-executable instructions embodied thereon that, when executed, perform a method for performing a caching action based on end-user cues, the method comprising:
detecting, at a sensor associated with a display providing content, an indication corresponding to intent of a user;
predicting the intent of the user based on the indication and historical information; and
preemptively caching additional content based on the intent of the user.

2. The media of claim 1, wherein the historical information corresponds to the user.

3. The media of claim 1, wherein the historical information corresponds to the content.

4. The media of claim 1, further comprising loading the additional content in the background without changing the display providing content.

5. The media of claim 4, further comprising, upon receiving an interaction from the user, changing the display to provide the additional content.

6. The media of claim 1, further comprising determining the indication based on gaze detection corresponding to the user.

7. The media of claim 1, further comprising determining the indication based on pressure detection corresponding to a user device.

8. The media of claim 7, wherein the user device is a keyboard.

9. The media of claim 1, further comprising determining the indication based on movement detection corresponding to a user device.

10. The media of claim 9, wherein the user device is a mouse or touch-sensitive device.

11. The media of claim 1, further comprising determining the indication based on hover detection corresponding to a user device.

12. A method for performing a caching action based on end-user cues, the method comprising:
detecting, at a sensor associated with a display providing content, an indication corresponding to user intent of a user;
predicting the intent of the user based on the indication and historical information; and
ceasing preemptively caching additional content based on the intent of the user.

13. The method of claim 12, wherein the historical information corresponds to the user, the content, or a combination thereof.

14. The method of claim 12, further comprising determining the indication based on gaze detection corresponding to the user.

15. The method of claim 12, further comprising determining the indication based on pressure detection corresponding to a user device.

16. The method of claim 12, further comprising determining the indication based on movement detection corresponding to a user device.

17. The method of claim 12, further comprising determining the indication based on hover detection corresponding to a user device.

18. A system for performing a caching action based on end-user cues, the system comprising:
at least one processor; and
one or more computer storage media storing computer-readable instructions that when executed by the at least one processor, cause the at least one processor to perform operations comprising:
detecting, at a sensor associated with a display providing content, an indication corresponding to intent of a user;
predicting the intent of the user based on the indication and historical information; and
performing a caching action corresponding to additional content based on the intent of the user.

19. The system of claim 18, wherein the caching action is to preemptively cache the additional content.

20. The system of claim 18, wherein the caching action is to cease preemptively caching the additional content.
